(19) United States
(12) Patent Application Publication
(10) Pub. No.: US 2020/0062610 A1
(43) Pub. Date: Feb. 27, 2020

(54) Method for Reducing the Bandgap of Titanium Dioxide

(71) Applicant: Hisao Yamada, Chagrin Falls, OH (US)

(72) Inventor: Hisao Yamada, Chagrin Falls, OH (US)

(21) Appl. No.: 16/113,874

(22) Filed: Aug. 27, 2018

(51) Int. Cl. C01G 23/08; C01G 23/053; C01G 39/02

(52) U.S. Cl. CPC C01G 23/08; C01G 23/053; C01P 2002/70; C01P 2002/30; C01P 2006/40; C01G 39/02

(57) ABSTRACT

This invention describes a new method for reducing the bandgap of titanium dioxide by forming solid solutions with other dioxides that a) have either rutile or anatase crystal structure, b) exhibit either metallic or semiconducting characteristics and c) maintain stable 4+ valence during high temperature processing as well as during cooling to room temperature.

### BACKGROUND

Hydrogen is the cleanest fuel for uses in power generation and transportation. The technology of producing hydrogen has progressed considerably since the discovery of the decomposition of water by electric current by Nicholson and Carlisle in 1800 followed by Faraday's discovery of the laws governing electrolysis in 1833. At present most of hydrogen is produced by schemes such as the steam reforming of methane or the partial oxidation of petroleum. With the advent of the age of diminishing fossil fuels and concerns in global warming, reappraisal of older technologies for producing hydrogen such as electrolysis and development of newer methods to produce hydrogen directly from thermal energy or sunlight has begun.

In 1972 Fujishima and Honda achieved ultraviolet light-induced water cleavage using a titanium dioxide photo-anode in combination with a platinum counter electrode soaked in an aqueous electrolyte solution¹. This discovery opened up the possibility of producing hydrogen by sunlight using semiconductors. An ideal semiconductor for photo-anode for solar photo-electrochemical cleavage of water must satisfy the following characteristics simultaneously. First, its band-gap must be 1.6 to 1.7 eV. Secondly, its band edges must straddle H₂O redox potentials. Thirdly, it is stable (meaning corrosion-resistant) in a highly oxidizing aqueous solution. Since the band-gap of rutile (TiO₂) is ˜3 eV, only light with their wavelengths shorter than 400 nm can be utilized for light-induced water cleavage. Thus many attempts have been made to reduce or sensitize large band-gap semiconductors or to utilize narrow band-gap semiconductors that can absorb visible light. For example, a decrease in band-gap of mere 0.75 eV would enable photo excitation by green light (550 nm). Since solar irradiation at the Earth's surface is 1.2 Wm⁻² nm⁻¹ at wavelength of 550 nm as compared to 0.2 Wm⁻² nm⁻¹ at wavelength of 400 nm, a significant improvement in the efficiency of the photo-electrochemical cleavage can be expected. However, as far as water photolysis is concerned, utilization of visible light for water cleavage has been unsuccessful.

### PRIOR ART

In addition to TiO₂ it has been demonstrated that other oxide semiconductors such as SrTiO₃, CaTiO₃, KTaO₃, and ZrO₂ are capable to photolyze water². Among these oxides SrTiO₃ has been extensively investigated as an alternative to TiO₂. Since the conduction band edge of TiO₂ is slightly lower (less negative) than that necessary to evolve hydrogen by sunlight, it has been necessary to employ anolyte and catholyte with different pH values, higher in the former and lower in the latter, for photolysis of water. On the other hand SrTiO₃ has a sufficient negative conduction band edge and thus is able to photolyze water without additional driving force. However, with its large band-gap of 3.2 eV the efficiency of solar energy conversion is very low. Many attempts have been made to reduce the bad-gap of TiO₂ including doping. The doping of TiO₂ with aliovalent cations introduces either acceptor or donor sites, but does not alter the band-gap of TiO₂. In addition to oxide semiconductors compound semiconductors with reduced band-gaps such as GaInP₂ have been investigated as potential photo-catalysts for photolysis of water. However, they suffer significant photo-corrosion and are not viable for long-term uses.

A theoretical study indicates that the band-gap of a semiconductor can be modified by mixing two semiconductors with different band-gap energies³. Since then it has been experimentally demonstrated that the band-gap of CdSe can be modified by preparing a mixed semiconductor,

CdSe₍₁₋ₓ₎Teₓ⁴. Furthermore, the work on Ti₍₁₋ₓ₎CrₓO₂ by chromium ion implantation⁵ demonstrated that the band-gap of the solid solution decreases linearly with increasing X. However, a thermodynamic barrier prohibits the uses of conventional thermal processing methods to form Ti₍₁₋ₓ₎CrₓO₂ solid solution.

### SUMMARY OF INVENTION

Song and Yamada worked on an oxide pair between TiO₂ and NbO₂⁶. Unfortunately, Nb⁵⁺ ions are more stable than Ti⁴⁺ ions and thus it was not possible to form a solid solution Ti₍₁₋ₓ₎NbₓO₂. However, based on the study Yamada formulated basic criteria for making reduced band-gap oxide semiconductors by forming solid solutions between TiO₂ and MO₂. The criteria for MO₂ are as follows:

1. MO₂ must have either a rutile or anatase crystal structure,

2. MO₂ must be either a metallic conductor or semiconductor, and

3. Both Ti⁴⁺ and M⁴⁺ must maintain their 4+ valence during synthesis at elevated temperatures and during cooling to room temperature.

There are three distinct groups of oxides that meet the criteria listed above. The first group is either MoO₂ or VO₂ that is stable in reduced atmospheres at elevated temperatures. The second group is either CrO₂ or MnO₂ that is stable in oxidizing atmospheres at elevated temperatures. The third group is the noble metal oxide such as PtO₂ and IrO₂ that is also stable in oxidizing atmospheres. These noble metal oxides are quite expensive and thus, unless they possess some unique characteristics still unknown, it might not be justifiable to be used in large industrial applications.

### BRIEF SUMMARY OF FIGURES

FIG. 1: The band gap of the solid solution between TiO₂ and MoO₂.

The bandgap is determined by the optical diffuse scattering method. In the FIGURE a straight line is drawn to connect the bandgap of pure titanium dioxide and that of pure manganese dioxide.

### DETAILED DESCRIPTION OF THE PREFERRED EMBODIMENT

The present invention will now be described in detail. The solid solution between TiO₂ and MoO₂ is the only pair amenable to the conventional ceramic powder processing method. (1−x)TiO₂-xMoO₂ with x between 0.1 and 0.6 is synthesized by mixing TiO₂ and MoO₂ powers. Subsequently the mixture is placed in a platinum crucible. Then the crucible is inserted in a muffle tube furnace and heated to 1,200° C. for 10 to 100 hours in flowing gas mixture of CO₂ and CO. The ratio of CO₂ to CO is maintained 10:1. After firing at the temperature the crucible is cooled to room temperature while maintaining the gas flow. X-ray fluorescence analyses indicate that the resulting solid solution lost a significant amount of MoO₂. XRD analyses indicate that the resulting solid solution has a rutile crystal structure.

In order to minimize the volatility of MoO₂ at elevated temperatures, an alternative method is also employed to obtain uniform mixtures of titanium(IV) and molybdenum(IV) ions. In the method aqueous solutions of titanium(IV) oxalate and oxy-molybdenum(IV) oxalate are mixed at a desired proportion. Then water is allowed to evaporate while the solution is continuously stirred to obtain dry cake. Subsequently the cake is ground and fired in air at 500° C. while the oxygen partial pressure of the effluent gas is monitored continuously. When the decomposition of the oxalate mixture approaches completion, the oxygen partial pressure starts to increase sharply. At this point the flow of gas is switched from air to 10:1 CO₂ to CO gas mixture and the temperature is raised to 700° C. After firing at the temperature for a few hours the crucible is cooled to room temperature while maintaining the gas flow. XRD analyses indicate that the resulting solid solution has a rutile crystal structure.

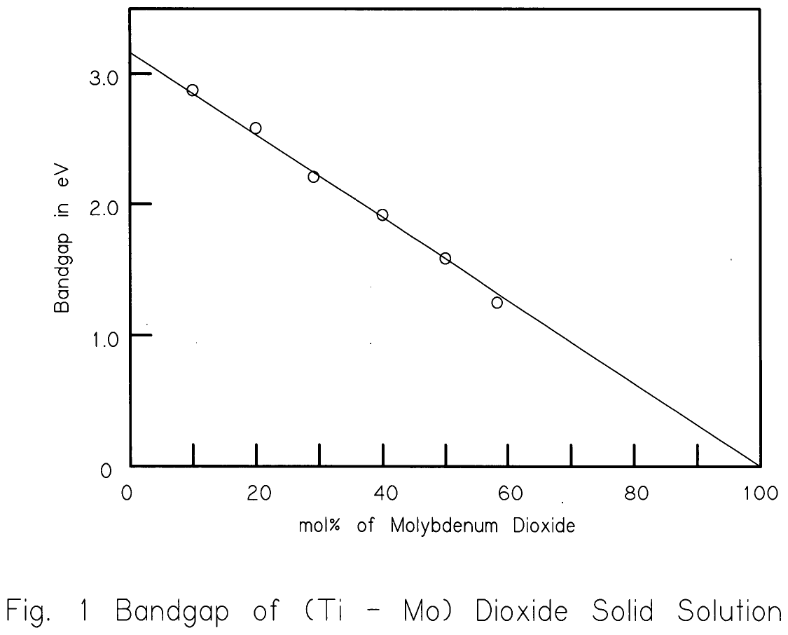

Since the photo-anode of a photo-catalytic decomposition system requires a thin layer, ˜5 microns thick, the sol-gel method is also employed to synthesize (1−x)TiO₂-xMoO₂. Titanium butoxide, Ti(IV)(O-Bu)₄, and Molybdenum butoxide, Mo(IV)(O-Bu)₄ are mixed at a desired proportion and allowed to form a sol in the presence of acetic acid and using acetylacetone as a chelating agent. The resulting sol is spin-coated on a metallic substrate, such as gold or platinum. After the film is dried, the coated substrate is heated in air to 400° C. while the oxygen partial pressure of effluent gas is continuously monitored. When the decomposition of the film approaches completion, the oxygen partial pressure starts to increase sharply. At this point the flow of gas is switched from air to 10:1 CO₂ to CO gas mixture and the temperature is raised to 700° C. After firing at the temperature for a few hours the substrate is cooled to room temperature while maintaining the gas flow. Their band gaps are determined from the optical diffuse scattering measurements and are shown in FIG. 1.

The solid solutions between TiO₂ and VO₂ are synthesized as follows. The solutions of Titanium(IV) isopropoxide and Vanadium(IV) butoxide are mixed at a proper proposition to form (1−x)TiO₂-xVO₂ with x between 0.1 and 0.6. The mixed solution is then spray-coated on a substrate, either platinum or stainless steel. After drying the film is fired in air at 600° C. for a few hours. While the film is fired at the temperature, the oxygen partial pressure of the effluent gas is monitored continuously. When the oxygen partial pressure of the effluent gas hits 10⁻⁵ atm, the air flow is shut off. During the rest of the time, the oxygen partial pressure is maintained between 10⁻³ and 10^{-6.5} atm. The coated substrate was cooled to room temperature while the oxygen partial pressure is reduced from 10^{-6.5} to 10⁻⁴⁰ atm. linearly with decreasing temperature. The films are found by XRD to have mixed phases of rutile and anatase. The band gaps of the films are determined by the optical diffuse scattering method and the results are similar to those in FIG. 1.

### REFERENCES CITED

1. A Fujishima and K. Honda, Nature, 238, 37 (1972)
2. Chapters 15 & 16 in “Photocatlysis” ed. by K. Kaneko and I. Okura (200)
3. H. C. Cassy and M. B. Panish, in “Heterostructure Laser,” pub. by Academic Press, New York (1978)
4. D. E. Scaife, Solar Energy 25, 41 (1980)
5. M. Anpo, Pure Appl. Chem., 72(9), 1787-92 (2000)
6. I. Song, “Defect Structure and DC Electrical Conductivity of TiO₂—NbO₂ Solid Solution”, Ph. D. Dissertation, Case Western Reserve University (1990)

1. Solid solutions of TiO₂ with MO₂ where MO₂ has the following characteristics; a) has a crystal structure of either rutile or anatase, b) is either metallic conductor or semiconductor and c) maintains their stable 4+ valence during processing.

2. In claim #1 MO₂ is MoO₂.

3. In claim #2 solid solutions of TiO₂ and MoO₂ are processed with the sol-gel method using organometallic compounds of and Mo⁴⁺ and fired at elevated temperatures in CO₂—CO gas mixtures with their CO₂/CO ratio of between 10⁴ and 1.
